(19) United States
(12) Patent Application Publication
(10) Pub. No.: US 2024/0370740 A1
(43) Pub. Date: Nov. 7, 2024

(54) SYSTEM AND METHOD FOR IDENTIFYING FOOD TYPES USING A CONVOLUTIONAL NEURAL NETWORK AND UPDATING IDENTIFICATION MODEL WITHOUT RETRAINING

(71) Applicant: WHIRLPOOL CORPORATION, BENTON HARBOR, MI (US)

(72) Inventors: Mohammad Haghighat, San Jose, CA (US); Mohammad Nasir Uddin Laskar, Sunnyvale, CA (US); Harshil Shah, Sunnyvale, CA (US); Bereket Sharew, Santa Clara, CA (US)

(73) Assignee: WHIRLPOOL CORPORATION, BENTON HARBOR, MI (US)

(21) Appl. No.: 18/686,510

(22) PCT Filed: Aug. 27, 2021
(86) PCT No.: PCT/US2021/047872

§ 371 Date: Feb. 26, 2024

(51) Int. Cl. G06N 5/02; G06N 3/0464

(52) U.S. Cl. CPC G06N 5/02; G06N 3/0464

(57) ABSTRACT

A method (110) for operating a cooking appliance (10) includes receiving data (16) from an image sensor (14) operably associated with a food-receiving area (12) of the cooking appliance (10), the data (16) comprising an image (24) of a food product (F), determining whether the image (24) of the food product (F) corresponds with one of a plurality of known food product types accessible by the cooking appliance (10) based on an analysis of the image (24) of the food product using an identification model (31), and in response to the image (24) of the food product (F) not corresponding with any one of the plurality of known food product types, designating the image (24) of the food product (F) as a new food product type and causing the new food product type to be added to the plurality of known food product types accessible by the cooking appliance without retraining the identification model (31).

### BACKGROUND OF THE DISCLOSURE

The present disclosure generally relates to a system and method for identifying food in connection with a cooking appliance, and more specifically, to the use of a convolutional neural network to identify a food type as unknown and register the food type as new without retraining the identification model of the convolutional neural network.

Food recognition systems have been developed as deep convolutional neural network (“CNN”)-based classifiers. These systems take an input of an image of food inside, for example an oven, and output a list of probability values for each of a number of predefined classes known to the system. The food recognition ability of such a classifier is limited to the number of food classes upon which the CNN is trained. For example, if a CNN-based classifier is trained using the images of thirty different types of food, the output of the system will be 30 probability values output by a Softmax (normalized exponential) function. The sum of all these 30 probability values is 100%, and the recognized food type is the one that has the highest probability. Accordingly, it will be appreciated that such a system cannot recognize “unknown” foods. For example, a user places a new food type that does not belong to any of those thirty known classes in the example oven, the recognition system will still output the 30 probability values, and one of them will be larger than the others. The oven will, accordingly, return the class corresponding to the highest probability as the recognition, which will incorrectly identify the food type.

The above mentioned deep CNN-based classifiers are trained using an extensive database of images of food from predefined classes, with the food type being known and pre-associated with the images. This training may require at least hundreds and, preferably, thousands of images, per class, to achieve a generally acceptable product-level accuracy. To add even one more food type to the list of recognizable food classes requires a collection of thousands of images of that food, addition of those images of the database maintained or accessible to the CNN, and complete retraining of the classifier. This process can only be done by the manufacturer of the appliance or programmer of the CNN, presenting a significant barrier to giving end users the ability to add new, personalized food types to the CNN in their own appliances, for example. Even at the manufacturer or programmer level, training a new identification model takes a considerable amount of time and computation resources.

### SUMMARY OF THE DISCLOSURE

In view of the foregoing, a CNN-based embedder and related methods are disclosed that are capable of adding new classes to the identification model without retraining. According to one aspect of the present disclosure, a method for operating a cooking appliance includes receiving data at least from an image sensor operably associated with a food-receiving area of the cooking appliance, the data comprising an image of a food product, determining whether the data indicates that the food product corresponds with one of a plurality of known food product types stored in a memory accessible by a controller of the cooking appliance based on an analysis of the data using an identification model accessible by the controller, and in response to the data indicating that the food product does not correspond with any one of the plurality of known food product types, designating the data as corresponding with a new food product type and causing the new food product type to be added to the plurality of known food product types stored in the memory accessible by the controller of the cooking appliance without retraining the identification model.

According to another aspect of the present disclosure, a use of a convolutional neural network to control a cooking appliance includes receiving data at least from an image sensor operably associated with a food-receiving area of the cooking appliance, the data comprising an image of a food product, generating a new vector of the data and embedding the vector in a feature space comprising a plurality of embedded vectors pre-arranged in a plurality of clusters within the space according to similarity of a predetermined number of features represented in the embedded vectors, each of the plurality of clusters corresponding with a known food type, determining a closest one of the plurality of clusters to the new vector within a predetermined threshold, assigning the corresponding food type to the image data associated with the new vector, and heating the cooking appliance according to a pre-programmed cooking mode associated with the corresponding food type, and if no closest one of the plurality of clusters to the new vector is within the predetermined threshold, registering the new vector in a new cluster in the feature space associated with a new food type and heating the cooking appliance according to a user setting in a manual cooking mode.

According to yet another aspect of the present disclosure, a multi-dimensional feature space useable by a neural network in classifying a data includes a plurality of clusters of embedded vectors arranged within the multi-dimensional feature space according to similarity of a predetermined number of features perceived in the data during training of the neural network, and at least one new vector arranged within the multi-dimensional feature space according to the predetermined number of features after training of the neural network and without retraining the neural network.

According to yet another aspect of the present disclosure, a cooking appliance, preferably an oven includes a food-receiving area, preferably an interior cavity, an image sensor outputting image data of at least a portion of the interior cavity, and a controller receiving the image data. The controller generates a new vector of the image data and embeds the new vector in a feature space comprising a plurality of embedded vectors pre-arranged in a plurality of clusters within the space according to similarity of a predetermined number of features. Each of the plurality of clusters corresponds with a known food type. The controller then determines a closest one of the plurality of clusters to the new vector, within a predetermined threshold, and assigns the corresponding food type to the image data associated with the new vector. If no closest probable one of the plurality of clusters to the new vector is within the predetermined threshold, the controller registers the new vector in a new cluster in the feature space associated with a new food type.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an example cooking appliance according to an aspect of the disclosure including an image sensor;

FIG. 2 is a side cross-section view of the appliance of FIG. 1;

FIG. 3 is a schematic diagram showing the incorporation of a controller including a food recognition system using a method according to an aspect of the disclosure;

FIG. 4 is a schematic depiction of a convolutional neural network useable by the controller in the food recognition system and operating according to the method;

FIG. 5 is a simplified depiction of a feature space having vectors representing perceptions of features of images of food by the convolution network embedded therein prior to training of the convolutional neural network;

FIG. 6 is a simplified depiction of the feature space having the vectors grouped in clusters according to a classification of the image by training of the neural network;

FIG. 7 is a three-dimensional depiction of the feature space represented as a sphere; and

FIG. 8 is a flowchart depicting a method for identifying food in connection with the use of an appliance according to an aspect of the disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooking appliance and associated methods for operation of the appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

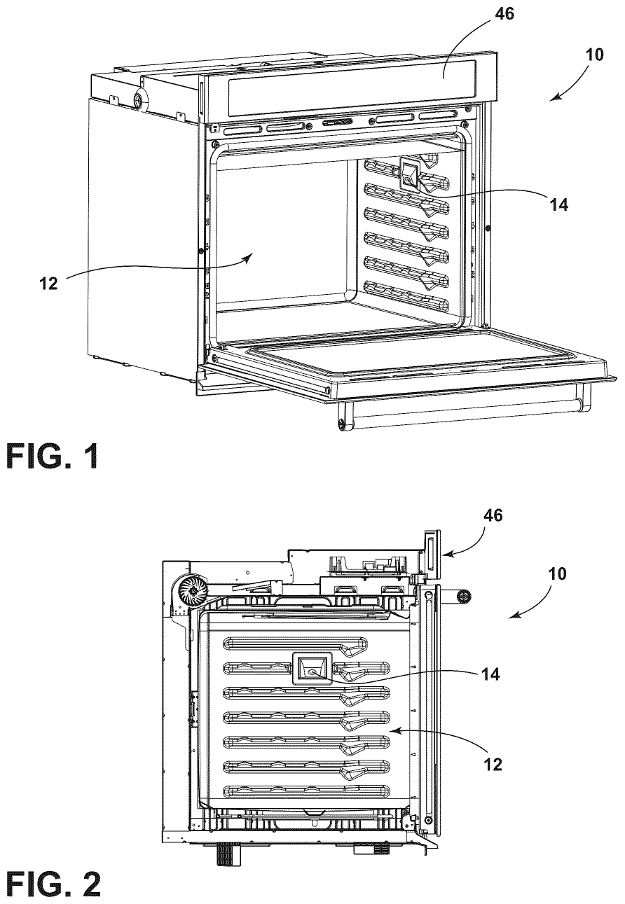

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

Referring to FIGS. 1-3, reference numeral 10 generally designates an oven that includes an interior cavity 12, an image sensor 14 outputting image data 16 of at least a portion of the interior cavity 12, and a controller 18 receiving the image data 16. In certain aspects, discussed further below, the oven 10 can be characterized as a “smart” appliance with the controller 18 having access to or otherwise associated therewith memory 20 that includes a database of recipes associated with various types of food that can include, for example, preset temperatures and cooking times to implement in an automated cooking program associated with a known food type. Additionally, the oven 10 can include the capability to identify the type of food placed into the interior cavity 12 by the user without additional selection or intervention by the user (aside from confirmation and/or initiation of the automated cooking program, as discussed further below). In particular, the controller 18 can subject at least the image data 16 received from the image sensor 14 to an identification model 31 executed by a convolutional neural network (“CNN”) that can determine if the food represented in at least the image data 16 corresponds with a known food type. Additionally, the model can assess whether the food represented in the data 16 does not correspond with a known food type closely enough to associate the food with any of the known types and can add the food to the model as a new food type, without requiring that the model be retrained.

In general, the oven 10 shown in FIGS. 1-3 is representative of a smart appliance with the identification capabilities mentioned above and discussed in further detail herein, with it being appreciated that other appliances can include the controller 18 utilizing the identification model 31 discussed herein in a similar manner in connection with the cooking and heating capabilities thereof. For example, toaster ovens, slow-cookers, multi-function cooking pots, microwave ovens, grills, and cooking hobs can be operated according to the principles and concepts discussed herein, including by incorporation of the controller 18 and the image sensor 14, configured according to the descriptions herein. In this respect, it is noted that the image sensor 14 shown in FIGS. 1-3 is generally depicted as being included a video camera 15 that captures a visible light-based image using a lens the image sensor 14 to encode the image in the image data 16 for transmission to the controller 18. Further implementations of such an image sensor 14 can additionally or alternatively include other arrangements for capturing other types of images, including infra-red camera arrangements, ultrasonic imaging equipment, LIDAR (or other laser-imaging) equipment, or the like to capture or assess additional characteristics present in such alternative images, but not in visible light images. Even further, additional sensors, such as humidity or gas sensors can also be included in the oven 10 and can output additional data related to non-visual or non-image characteristics of the food, including a profile of prominent gasses expressed from the food product (F) or a humidity profile associated with the food product (F). The particular sensors used, including the configuration of the image sensor 14, in some respects, can be selected or adapted depending on the particular appliance with which the image sensor 14 is associated. In the example depicted in FIGS. 1 and 2, the camera 15 can alternatively be positioned along the top of the interior cavity 12 of the oven 10 to have a top-down view of the food product F, rather than the oblique view of the side wall mounted image sensor 14 shown in the Figures. In addition to the example of the image sensor 14 included in the camera 15 shown within and operably associated with the interior cavity 12 (e.g., the food-receiving area of the oven 10), an appliance according to the present disclosure in the form of a cooktop can be connected (physically or electronically) with a camera 15 included in an overhead vent hood associated with the cooktop and directed downwardly toward the designated cooking areas that collectively comprise the food-receiving area of the cooktop. Such a vent can similarly include additional image sensors 14, as described above, as well as additional sensors, including but not limited to humidity and gas sensors. Other configurations and/or arrangements are to be understood, at least based on the description herein.

As can be appreciated, the controller 18 can, in at least one implementation, be a microprocessor having the computational capacity for executing the control methods discussed herein. The specific architecture of the controller 18 and its incorporation into the oven 10, or other cooking appliance, can vary. In one implementation, the controller 18 can be a microprocessor that executes a program, stored in the memory 20, for operation of the oven 10. Alternatively, the controller 18 can be an application-specific integrated circuit (“ASIC”). The memory 20 can be packaged with the controller 18 (i.e. a “system-on-chip” configuration) or can be connected with the controller 18 by associated circuitry and/or wiring. The controller 18 and/or memory 20 can also include firmware for operating the image sensor 14, as well as for controlling the operation of the oven 10, including additional operations not necessarily encompassed within the “smart” features discussed herein.

As discussed above, the controller 18 is configured to utilize a CNN 22 to determine if food or a food product F positioned in or on the food receiving portion of the appliance (i.e., the interior cavity 12 of the oven 10) corresponds with one of the known food product types. More particularly, and as shown schematically in FIG. 4, the controller 18 uses the CNN to process at least the image data 16 in the form of, for example, a still image 24 captured of the food F within the interior cavity 12 to derive a vector 26, or a 1×n matrix, with values related to features captured from the images as spatial and temporal dependences through the application of relevant filters. As depicted, the image 24 received from the image sensor 14 is subjected to successive layers of combined convolution and rectified linear activation unit (“RELU”) functions 28 and pooling functions 30 to “extract” high level features from the raw image data 16 as values indicating the perception of the features by the network while reducing the total number of overall features associated with the image 24. In doing so, the computational load on the controller 18, for example, is reduced. By way of example, a 10 megapixel RGB image includes over 10 million pixels that each include three channels of image data (i.e., red, green, and blue) such that the image 24 can be said to include over 30 million “features”. By way of example only, the present CNN can be configured to take such an image 24 as an input and apply an appropriately-configured set of layers 28 and 30 to output a vector 26 having less than 200 values, and in one embodiment about 128 features (+/−10%), corresponding with the extracted features of the food F captured in the original image 24. It is noted, however, that the description herein is for explanation only, with details, including the number of features, being specified to provide a thorough understanding of the disclosed concepts. It is to be understood, therefore, that the concepts disclosed herein can be practiced without, or with modifications to, the specific details provided herein. In at least this respect, it is to be appreciated that more or fewer features than those used in the specific examples provided herein. As can further be appreciated, the various kernels used in the convolution and RELU layers 28 can be selected to filter various features related to different characteristics or aspects of the image data 16, including but not limited to edges, texture, color composition and variation, and feature size, shape, and/or density. In specific implementations of the oven 10 (or other appliances or uses of CNN 22 discussed herein) that include an image sensor(s) 14 outputting additional image data (i.e. a LIDAR image, an infrared image, etc.) or additional non-image data (e.g., humidity or gas profiles), such data can be similarly included in the overall data processed by the perception model 27 and can be included as additional values in the same vector 26 based on perception of the additional data similar to the described perception of the visible image data. In this respect, it is noted that the oven 10 described herein, as well as the methods of operation and use of the CNN 22 described herein can function, as described, using only visible image data. In some respects, one or more of non-visible image data or non-image data obtained from one or more additional sensors or the types described herein can be added to augment operation of the CNN 22 and/or to add additional relevant data for use in the identification described herein. It is contemplated that the oven 10, controller 28, and/or CNN 22 can be configured to operate using the described visible image data, non-visible image data, and non-image data alone or in various combinations thereof, including but not limited to: visible image data alone; visible image data and non-visible image data; visible image data and non-visual data; visible image data, non-visible image data, and non-image data; and other variations developed according to the principles discussed herein. Accordingly, it is understood that, while various examples discussed herein, may refer only to images and image data, additional types of data can be added and processed in a similar manner to that which is described in connection with the examples.

As further illustrated, the CNN 22 includes a fully connected layer 32 that associates the features of the vector 26 with the output(s) of the CNN 22. In particular, the CNN 22 is configured to output one of a set of known food types corresponding with the data 16 or that the data 16 corresponds with a “new” food type. As can be appreciated, the fully connected layer 32 is realized by training the CNN 22, by which the CNN 22 determines various weights and biases associated with the various features that can fit an initial data set to a plurality of “classes” of the data, such as through back-propagation or other known means. Presently, the classes correspond to the initial set of known food types on which the model is trained. By way of example, the CNN 22 can be trained on an initial set of 30 known food types (although the CNN 22 can be trained on any desired number of initial known food types, including as little as 10 or as many as 200 food types or more) corresponding with foods (e.g. broccoli, asparagus, potato, whole turkey, chicken breast, etc.) or prepared dishes (e.g. apple pie, pizza, samosa, casserole, etc.), or the like. Known CNNs used for image recognition are typically configured as “classifiers” that, for example, use a Softmax function to output probabilities associated with the known classes, with the image being classified as the known class with the highest probability. In this respect, the CNNs are trained to fit the initial data to the known classes pre-associated with the data. Once the model is trained, the CNN associates new image data 16 with one of the known classes (i.e., the class with the highest Softmax probability). While it may be possible to require a level of certainty to output a positive identification, such as threshold probability, minimum error, etc., such CNNs are likely to output an incorrect class when the image data 16 does not correspond with one of the known classes on which the model is trained. Moreover, the addition of a new class requires complete retraining of the model to re-fit the data with the revised set of classes and, further, may require the use of hundreds or thousands of images, for example, of the new class for training on the new class. Accordingly, it can be appreciated that new classes cannot practically be added by the consumer of an appliance, such as the present oven 10 that includes a food classifier.

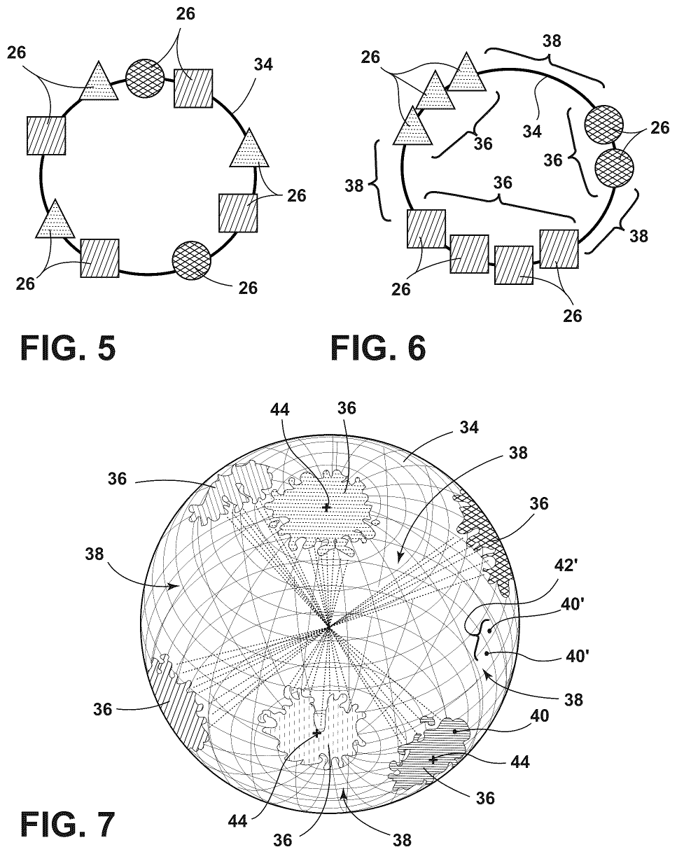

The present CNN 22, as shown in FIG. 4 and, further, in FIGS. 5-7, is configured to operate without using a Softmax probability, but rather to “embed” vectors 26 corresponding with the initial data set on which the CNN 22 is trained, as well as new vectors 26 derived from later images 24 analyzed by the CNN 22, in a feature space having a number of dimensions equal to the number of features included in the vectors 26 realized by the feature learning layers of the CNN 22. In particular, the vectors 26 are normalized to represent coordinates on a unit hypersphere 34 represented by:

$${‖ f ( x ) ‖}_{2} = 1. \qquad ( 1 )$$

In this respect, the value for a given feature (i.e., cell) in a given vector 26 can indicate the position of the vector 26 within the corresponding dimension, with the complete vector 26 locating the embedded entry within the complete feature space. The schematic depiction in FIG. 5 shows the feature space 34 as a circle corresponding with just two features for purposes of a simplified explanation of the embedding and training achieved by the CNN 22. In the simplified depiction, the initial embedded vectors 26 represent images of food across three different known food types (represented by different shapes having unique shading) on which the hypothetical, simplified CNN 22 is trained.

Prior to training of the CNN 22, the embedded vectors 26 are scattered and intermixed along the feature space 34, as shown in FIG. 5. While the CNN 22 can be trained using similar methods known for training classifiers (including back propagation of gradients and updating of weights), the initial calculation is not based on an input to a Softmax probability calculation in the form of probabilities related to the number of known classes. The training of the CNN 22, rather, is based on the overall distances in the feature space 34 between the vectors 26 within the same class. With an appropriately-trained embedding layer 32 based on minimizing the in-class distances of vectors 26 (i.e., appropriate location of vectors 26 within the feature space 34 based on the image perception), the convolution and RELU layers 28 can be trained similarly to those used in a classifier CNN, including using known machine-learning libraries such as Tensorflow, Keras, or PyTorch, to accurately extract relevant features from the image data 16. After the CNN 22 is trained, the vectors 26 will be arranged in clusters 36 of the known food types on which the model is trained, as shown in FIG. 6. Sufficient training of the CNN 22 will also introduce and increase the presence of open space 38 between the clusters 36. This effect is illustrated in FIG. 7, which depicts the hypersphere 34 in three dimensions, reflecting the fitting of the vectors 26 with three features about the surface of the sphere. It is to be appreciated that, in application, the vectors 26 include more features than the two or three depicted in FIGS. 6 and 7, respectively. More particularly, as discussed above, the vectors 26 may include over 100 values representing a corresponding number of features, with the hypersphere 34 defining a feature space with a number of dimensions equal to the number of features represented in the vectors 26. In one example, the vectors 26 may have a length of 128 elements, with the hypersphere 34 defining a 128-degree feature space, although other vector lengths and corresponding dimensions are possible. Additionally, the actual clusters 36 derived from a real-world application of CNN 22 and the training thereof may have more complicated boundaries and may include clusters 36 that are closer together than in the depiction of FIG. 7 or may actually overlap to an extent. These characteristics may be due to variations of different implementations or realizations of foods within the same class (e.g., different types of pizza) or similarities of foods within different classes. For example, a fish fillet and chicken breast may have a similar shape, while being differentiated in relatively minor differences in color and texture. Accordingly, and as discussed further below, the clusters 36 may be represented by a mixture of Gaussian distribution.

Once the CNN 22 has been trained, data 16 comprising new images 24 captured by the image sensor 14 is perceived by the CNN 22 using the configured and trained convolution and RELU layers 28 and pooling layers 30 to derive corresponding new vectors 40 that are embedded into the hypersphere 34. Because of the training process applied to the CNN 22, any new vectors 40 will be embedded in the hypersphere 34 according to the similarity in perception of the images 24 to the existing vectors 26. In this respect, if the new image 24 is of a item corresponding with a known class-in the present example of a cooking appliance and, in particular, oven 10, then the resulting new vector 40 will be embedded within or close to the cluster 36 consisting of the other vectors 26 representing earlier images 24, including the training images. In this respect, the CNN 22 is configured to output an identification of the image as corresponding with a known class according to the closest cluster 36 to the newly-embedded vector 40, within a predetermined threshold distance or in combination with a probability that that the newly-embedded vector 40 fits within the class of the closest cluster 36. If the new vector 40 is not sufficiently close to an existing cluster 36 (i.e., is positioned within the open space 38 surrounding the clusters 36) and/or has a high probability of not fitting within the closest existing cluster 36, the CNN 22 can return an output indicating that the vector 40 and originating image 24 do not correspond with one of the known classes. In the present example, of a cooking appliance such as the oven 10 shown in FIGS. 1 and 2 and discussed further above, the clusters 36 can be composed of vectors 26 and 40 representing perceptions of images 24 of foods of the same category or type. At least initially, the clusters 36 can, more particularly, correspond with the known food types associated with the original vectors 26 on which the CNN 22 is trained. In this manner, a new image 24 obtained from the interior cavity 12 of the oven 10 that is embedded in the hypersphere 34 within the open space 38 will result in an output of an “unknown” food type. As can be appreciated, the availability of this output addresses one shortcoming of Softmax-based classifier, in that the present CNN 22 does not return a food type that is incorrect by forcing the output to correspond with a known class.

In addition to recognizing an unknown food type (or other unknown item in instances where the present CNN 22 is used for additional applications), the present CNN 22 can add new classes to the known, or trained, classes without retraining the model. Because the new vectors 40 are embedded in the same feature space (i.e., hypersphere 34) as the original vectors 26 embedded during training, the new vectors 40 are similarly available to the CNN 22 for proximity comparisons and probability evaluations in subsequent image recognition operations. Accordingly, the CNN 22 can, in various configurations, treat new vectors 40 within the open space 38 as comprising or being within a new cluster 42 that corresponds with a new, previously-unknown food type. Notably, such treatment is generally inherent in the CNN 22 configuration described herein, as the new vectors 40 and original (trained) vectors 26 are treated the same during use of the CNN 22 to perceive and identify subsequent images 24. The CNN 22, however, can be configured to require a certain number of new vectors 40 within a specified distance from each other or with specified relative distribution characteristics (as discussed further below) before taking steps to specifically designate the particular new vectors 40 as a new cluster 42, such as “registering” the cluster as a specific class and/or querying the user for the name or classification of the new cluster, for example. The specific configuration in this respect can vary depending the particular application of the CNN 22 and is discussed further below in connection with the specific examples provided herein.

The present CNN 22 can be configured to determine the proximity of a new vector 40 to the clusters 36 and 42 using a Mahalanobis distance, which is one known measurement between a point and a distribution, including along multiple dimensions. The Mahalanobis distance is unitless, scale-invariant, and takes into account the correlations of the data set. More particularly, the CNN 22, when trained to organize the original clusters 36 of the initial vectors 26 and registering the initial classes, can estimate a covariance matrix of each class for storage in memory 20 and association with the respective class. Subsequently, upon embedding the new vector 40 in the hypersphere 34, the CNN 22 can compute the Mahalanobis distance between the new vector 40 and, by nature of the calculation, a centroid 44 of each known cluster 36. Notably, the use of the covariance matrices of the clusters 36, the determination of the Mahalanobis distance accounts for significance in the directional location of the vector 40 relative to the clusters 36. More particularly, the determination of the Mahalanobis distance by the CNN 22 can account for variations of the normalized (Gaussian Mixture) distribution of the vectors 26 across the dimensions in the feature space by differentiating the initial vectors 26 in the clusters 36 and the new vectors 40 by Gaussian discriminant analysis, which results in a confidence score based on the Mahalanobis distance. In this respect, the CNN 22 may initially return an output of both the closest cluster 36 to the new vector 40 and the confidence score, which may be represented as a probability that the new vector 40 is a new, or currently unknown, food type. The CNN 22 can then apply a function or algorithm to effectively fuse the two outputs into a decision as to whether the new vector 40 corresponds with a known food type and the particular known food type identified (i.e., by the closest cluster 36 and a high confidence or low probability that the food type is unknown) or that the food type is unknown (i.e. by a low confidence score or a high probability that the food type is unknown, regardless of the identification of the closest cluster 36). In another implementation, the CNN 22 can apply a minimum threshold distance and identify the new vector 40 as being within a known class by the closest cluster 36 to the vector 40 within the predetermined threshold distance. If no cluster 36 is within the threshold Mahalanobis distance, then the new vector 40 is registered as a new class. In yet another variation, the Mahalanobis distance of the new vector 40 can be assessed in terms of the standard deviation of the vectors 26 of the particular cluster 36 to determine, for example, if the new vector 40 is an outlier with respect to even the closest cluster 36, which may indicate that the new vector 40 corresponds with a new class. In one aspect, the embedding of a new vector 40 within an original cluster 36 comprised primarily of initial vectors 26 may help improve the reliability of subsequent identification operations, simply by adding more data points to the model and without retraining.

Similarly, the CNN 22 can evaluate the proximity of subsequent new vectors 40 to other previously-added new vectors 40′ using the same Mahalanobis distance and/or confidence determination. Prior to registration of any or some of the new vectors 40′ as a new class, the proximity of the new vector 40 subjected to the current identification process to such un-registered vectors 40′ can be assessed directly using the Euclidean distance between the evaluated new vector 40 and the unregistered new vectors 40′ simultaneously with the Mahalanobis distance determination made with respect to the clusters 36. If the evaluated new vector 40 is closest to a previously-added new vector 40, with a corresponding confidence level, then the two new vectors 40 can be considered as corresponding with a new class and may be used to establish a new cluster 42 associated with that new class. A minimum distance threshold can be associated with this finding and can be on the order of the standard deviations of the original clusters 36, as discussed above. The new class can then be registered, including by associating a generic or preliminary identifier with the class and establishing a covariance matrix of the new vectors 40 in the new cluster 42. The association of the two new vectors 40 can be confirmed, including by the user in connection with the assignment of a name for the associated new class, as discussed further below. In alternative implementations, the CNN 22 can require more than two new vectors 40 in close proximity before registering the class in order to provide additional data points for improved accuracy in determining a covariance matrix, normalizing the distribution, and determining the Mahalanobis distance in subsequent identification operations. Specifically, such implementations may require three or more and in a more specific example 5 or 10 new vectors 40 within an expected cluster distance or size within the hypersphere 34 before registering the class. In such examples, the initial close distance between new vectors 40 below the registration threshold can be associated with the entries in memory 20 in an effective pre-registration process.

As discussed above, the CNN 22 described herein can be used to identify the type of food captured in the image 24 by the camera-based image sensor 14 included within or otherwise connected with a cooking appliance, such as the oven 10 shown in FIGS. 1-3 and discussed above. By arranging the image sensor 14 to capture an image of a food-receiving area of the appliance, such as the interior cavity 12 of the oven 10, the CNN 22 can identify the type of a food placed by the user of the appliance into or on the food-receiving area, including food placed into the interior cavity 12 of the oven 10 for heating and/or cooking therein. In similar variations discussed above, the CNN 22 can be used to identify foods placed in the interior of toaster ovens (or other countertop ovens), slow-cookers, multi-function cookers/processors, or on a cooktop. The identification of a food type can be used to execute specific cooking operations, including pre-programmed “recipes” based on the food type. These operations may include cooking time and temperature and can be implemented by the controller 18 of the appliance automatically upon identification of the food type and/or confirmation by the user. More specifically, in an example of an electric oven, the controller 18 can be configured to control activation of one or more electrical heating elements 48 within the interior cavity 12, via the associated circuitry 50, and may do so, according to a particular program or user setting to achieve the desired temperature within the interior cavity 12 for the desired duration. The operations may be more complex for certain types of food, including executing an initial baking phase at a first temperature for a first time followed by a browning phase at a higher temperature (or using the oven broiler element) for a second predetermined time, such as for casseroles or the like, or the inclusion of a resting or “keep warm” phase for meats or other types of food, with additional operations being possible based on known methods for cooking various foods.

Because the CNN 22 according to the present disclosure can determine that food placed into the food-receiving area (i.e., within the field of view of the image sensor 14) is not of a known type, the controller 18 can also operate by implementing a “manual mode” in response to the food type not being known. In the manual mode, the appliance 10 can allow the user to input and adjust the temperature and set any timers or additional programming (including automatic-off timers, or temperature change durations) that may be desired, such as by the presentation of manual controls on an HMI 46 mounted on a face of the appliance or the like. Additionally, because the new vector 40 associated with the image 24 used to attempt to identify the food type is embedded within the CNN 22, the parameters selected by the user in the manual mode can be stored in memory 20 in association with the new vector 40 for preliminary or later designation as a new food type according to the various configurations of the CNN 22 for doing so, discussed above. In this manner, the controller 18 can automatically associate a recipe with a new food type corresponding to a newly-registered cluster 42, according to the criteria and variations discussed above.

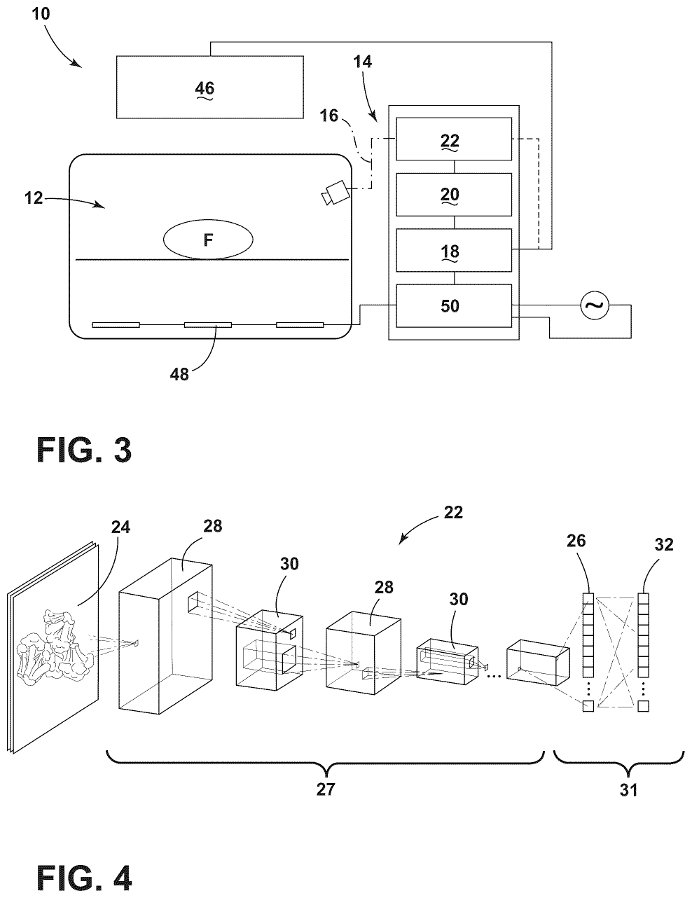

As is to be understood, further variations of the cooking appliance 10, as described herein, are contemplated, particularly with respect to the configuration of the memory 20 and the HMI 46. With respect to the memory 20 generally described and shown schematically in FIG. 3, at least a portion of the memory 20 may be physical memory within the appliance 10 that may include at least the programming for the general operation of the appliance 10, as used by the controller 18 to control the power status of the appliance 10 and or to manually set the cooking temperature, set timers, and the like. The physical memory can be RAM or other comparable form of physical memory and can be electrically connected with the controller 18 by way of mounting on the same integrated circuit or control board or may be packaged together in the above mentioned ASIC-type controller or a system-on-chip configuration, with other arrangements being possible. In various specific implementations, the CNN 22 can also be stored in the physical memory 20 within the appliance 10 in the form of the various matrices used in the convolution and RELU layers 28 and the pooling layers 30, as well as the programming to receive the image data 16, store the output of each layer 28 and 30 and apply subsequent operations to the output of each layer 28 and 30 in sequential fashion. Similarly, the fully connected layer 32 and embedded vectors 26 and 40 can also be stored in the local physical memory as additional matrices, as can any additional hidden activation layers and additional information, including relative positional information for non-registered new vectors 40 and covariance matrices of the registered clusters 36 and 42. In this respect, the CNN 22 can, initially, be a copy of a master CNN 22 that is pre-trained, including by the programmer/manufacturer of the controller 18 or appliance 10, with any new vectors 40 and resulting new clusters 42 and the corresponding registration information being unique to the individual appliance 10 once placed into use.

In other implementations, certain aspects, including one or both of the perception model 27 and the identification model 31 can be carried out over the internet (i.e., in a “cloud-based” application) at the request of the controller 18, including the transmission of the image data 16 over the internet to the appropriate server and the receipt of the output of the remote CNN 22. In this respect, a service provider (such as the manufacturer or an affiliate) can maintain various servers with versions or copies of the relevant CNN 22 for shared use and access among at least a subset of registered, compatible appliances 10. In such an application, the new clusters 42 can be made specific to the specific appliance or can be limited to certain areas/regions from which the vectors 40 from the clusters 42 originate, for example, which may reduce the number of new classes made available to users who are unlikely to use the appliance 10 to cook food in that class. In a similar manner, certain aspects of the HMI 46 can be made available to a remote device, e.g. a smartphone or the like, for control of the appliance 10 from a location away from the appliance 10 or to offer additional settings, controls, or information in a convenient, familiar form (e.g. a smartphone app). In one application, the additional settings or controls can include the ability to review or edit new classes and their designated type and/or to access or adjust the use history of the appliance and any recipes stored from the prior use of appliance 10 in connection with certain known or added food types.

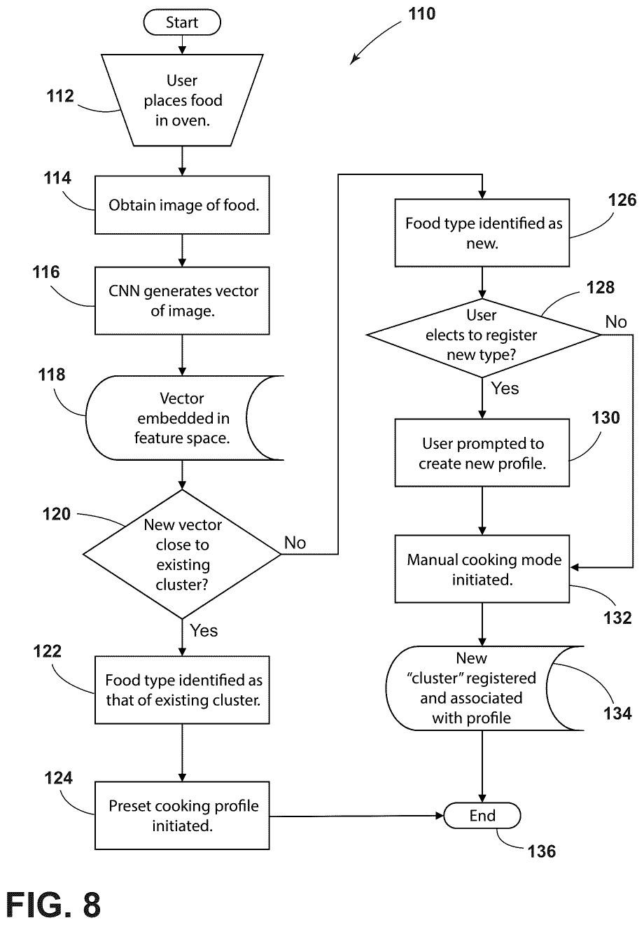

Turning to FIG. 8, a method 110 for operating a cooking appliance, such as the oven 10 depicted in FIGS. 1-3 or other appliances discussed above, including the use of the above-described CNN 22, is shown. In the depicted sequence, the method 110 begins when the user places food in the food-receiving area of the appliance, such as in the interior cavity 12 of the oven 10 described in various examples above (step 112). The controller 18 then receives at least the image data 16, which may be in the form of a still photographic image 24, from the image sensor 14, which may be, in one example, a digital camera operably associated with a food-receiving area 12 of the cooking appliance 10 (step 114). The method 110 further includes determining whether the image 24 of the food product corresponds with one of a plurality of known food product types accessible by the cooking appliance 10 based on an analysis of the image 24 of the food product using an implementation of the above-described identification model 31. More particularly, the method 110 includes using an implementation of the CNN 22, as described above, to use the perception model 27, including the convolution and RELU layers 28 and pooling layers 30 (having been configured and trained according to the principles discussed above) to develop a new vector 40 corresponding with the image 24 (step 116). Subsequently, the identification model 31, according to a specific implementation thereof, according to the above description, is used to embed the new vector 40 in the features space (e.g., hypersphere 34) (step 118) and to determine if the new vector 40 is sufficiently close to an existing cluster, including the original clusters 36 and any added clusters 42 of prior new vectors 40, such that the food placed in the interior cavity 12 corresponds with one of the known food types associated with the clusters 36 and 42 (step 120).

In response to the image 24 of the food product F not corresponding with any one of the plurality of known food product types (i.e., the new vector 40 not being within a threshold distance of any existing registered cluster 36 or 42), the method includes designating the new vector 40 associated with the food product F as corresponding with a new food product type (step 126). As discussed above, this step may include cataloging the vector 40 as a new, but still unidentified, food type and not yet registering the vector 40 as a cluster until a subsequent operation embeds another new vector 40 in close proximity to that previously-registered new vector 40 (or another predetermined number of other new, unregistered vectors 40). When the specific requirements of the particular appliance 10 are met (which may include a user indication via HMI 46 that a single new vector 40 should be registered as a new food type) (step 128), the vector 40 or plurality of proximate, unregistered new vectors 40 are registered as a new food product type that is added to the plurality of known food product types accessible by the cooking appliance 10 (step 134). This may include prompting the user to enter a name of the new food type for association with the new cluster 42 during registration (step 130). Notably, and as discussed above, the addition of the new food type to the CNN 22 is done without retraining the identification model 31 or the perception model 27. Additionally, when a new food type is identified, the appliance 10 can enter a manual mode (step 132) where, as discussed above, the user is presented options, such as on HMI 46, for entering a desired operating level or temperature for the appliance 10 and/or a desired cooking time (among other variations, as discussed above). If conditions for registration of a new cluster 42 as a new food type are met, and the user elects to add the new food type, the user can also be given the option to associate the selected manual cooking parameters with the food type as a recipe for use when the same food type is identified in a subsequent operation. Subsequently, the identification operation ends (step 136) and the cooking operation of the appliance 10 proceeds. It is to be appreciated that additional methods or variations of the above-described method will be apparent in view of the various alternative implementations of aspects of the CNN 22 and the configurations of the associated controller 18 or appliance 10, overall, as discussed above.

### EXAMPLE

The following example is put forth so as to provide those of ordinary skill in the art with a complete disclosure and description of how to make and use aspects of the present disclosure, and are not intended to limit the scope of what is regarded as the scope of the present disclosure, nor is it intended to represent that the experiment below is the only experiment performed. Efforts have been made to ensure accuracy with respect to numbers used (e.g. amounts, temperature, etc.) but some experimental errors and deviations should be accounted for. In the present example, a CNN according to the above description was developed including a perception model configured to convert three-channel color images of a size of 224×224 pixels to 1×128 vectors and a corresponding identification model configured to embed the vectors on a 128-dimension hypersphere. Initially, 143099 training images were processed by the perception model and embedded on the 128-dimension hypersphere. The images were of images of food within thirty-six initial classes of food types for training and were pre-associated with the correct food type corresponding with each image. The CNN was then trained on the initial images according to the food types, namely: asparagus, bacon, bagel, beef-roast-round, beef-steak, bread, bread-sliced, broccoli, brownies, Brussel-sprouts, carrot, casserole-chicken, casserole-tuna, cauliflower, cavity-empty, chicken-breast, chicken-nugget, chicken-whole, cookies, fish-fillet, fish-stick, french-fries, hamburger, lasagna, meatloaf, muffin-and-cupcake, pie-crust, pizza-sliced, pizza-whole, pop-tart, potato-cut-up, potato-whole, salmon-fillet, squash-butternut, toaster-strudel, waffle. The training was conducted, as discussed above to minimize the distances between vectors of the same class of food on the 128-dimension hypersphere.

The CNN was then tested over a sample of 5255 new images of food products including some within the known classes on which the CNN was trained and new food types not included in the initial training set. In particular, the training was conducted by using the perception model to develop new vectors representing the new images and using the identification model to embed the new vectors on the existing hypersphere, to simultaneously determine the closest existing cluster to the new vectors and assess the probability that the vector was of a new food type according to a Gaussian discriminant analysis. The identification model then fused the outputs to return a decision of either a known food type or a new food type for each image in succession. The decision of the CNN was then compared to the known food type associated with the test image and recorded. Over all of the samples, the CNN was able to correctly identify the image as corresponding with a particular one of the known food types or that the image was of a new food type with an accuracy of 90.73%. Additionally, when an image was correctly identified as a new food type, that new food type was registered in the CNN. In some instances, the same new food type was present in a subsequent test image, with the CNN being able to identify images as corresponding with a prior-registered new food type with an accuracy of 87%.

The invention disclosed herein is further summarized in the following paragraphs and is further characterized by combinations of any and all of the various aspects described therein.

According to an aspect of the present disclosure a method for operating a cooking appliance includes receiving data at least from an image sensor operably associated with a food-receiving area of the cooking appliance, the data comprising an image of a food product, determining whether the data indicates that the food product corresponds with one of a plurality of known food product types stored in a memory accessible by a controller of the cooking appliance based on an analysis of the data using an identification model accessible by the controller, and in response to the data indicating that the food product does not correspond with any one of the plurality of known food product types, designating the data as corresponding with a new food product type and causing the new food product type to be added to the plurality of known food product types stored in the memory accessible by the controller of the cooking appliance without retraining the identification model.

The identification model may be embodied in a convolutional neural network that includes a plurality of vectors embedded within a multi-dimensional feature space, each of the vectors representing previously-analyzed data comprising prior images of prior food products, the plurality of vectors being located in the multi-dimensional feature space such that ones of the plurality of vectors determined to have relatively higher similarities across a predetermined number of features perceived by the convolutional neural network are grouped in proximity with one another and are separated from other ones of the vectors having a lower similarity across the predetermined number of features and identifies ones of the plurality of vectors grouped in proximity with one another as pluralities of clusters of the ones of the vectors and registers the known food product types as respective ones of the plurality of clusters.

At least some of the embedded vectors can be arranged within the multi-dimensional feature space in original clusters according to similarity of the predetermined number of features during training of the neural network.

The analysis of the data may include using the neural network to generate a new vector from the image data and to embed the new vector in the multi-dimensional feature space according to the predetermined number of features.

In response to the data not corresponding with any one of the plurality of known food product types, the data may be designated as the new food product type and caused to be added to the plurality of known food product types by registering the new vector as a new cluster associated with the new food product type.

Whether the data corresponds with one of the plurality of known food product types accessible by the cooking appliance may be determined by the convolutional neural network determining a closest one of the plurality of clusters of embedded vectors to the new vector within a predetermined threshold using a Mahalanobis distance from the plurality of clusters.

The Mahalanobis distance from the plurality of clusters to the new vector can be based on a Gaussian Mixture distribution of each of the plurality of clusters.

The multi-dimensional feature space can include a number of dimensions that is equal to the predetermined number of features.

The method may further include, in further response to the data not corresponding with any one of the plurality of known food product types, prompting for a user-input of a cooking parameter according to a manual cooking mode.

The plurality of known food product types may comprise a plurality of original food product types and at least one added food type, the added food type having previously been added to the plurality of known food product types accessible to the cooking appliance without retraining the identification model and the original food product types being developed during training of the identification model.

The method may further include, in response to the data corresponding with one of the plurality of known food product types that is an added food type, prompting for a user-input of a category name for the added food type.

The data may additionally be received from one of a gas sensor or a humidity sensor and may further comprise at least one non-visual food product characteristic.

Each of the vectors representing previously-analyzed data may comprise prior images and non-visual food product characteristics of prior food products.

A cooking appliance may include a camera including the image sensor outputting image data of at least a portion of the food receiving area and the controller using the method as described above.

The cooking appliance may preferably comprise an oven further including a heating element and an interior cavity defining the food-receiving area of the cooking appliance, and the method used by the controller may further include operating the heating element according to a specified program in response to the data corresponding with one of the known food types or the new food type, respectively.

The plurality of known food product types and the identification model may be stored in memory included within the cooking appliance.

The controller may be configured to access at least one of the plurality of known food product types and the identification model over the Internet.

According to another aspect of the present disclosure, the use of a convolutional neural network to control a cooking appliance includes receiving data at least from an image sensor operably associated with a food-receiving area of the cooking appliance, the data comprising an image of a food product, generating a new vector of the data and embedding the vector in a feature space comprising a plurality of embedded vectors pre-arranged in a plurality of clusters within the space according to similarity of a predetermined number of features, each of the plurality of clusters corresponding with a known food type, determining a closest one of the plurality of clusters to the new vector within a predetermined threshold, assigning the corresponding food type to the data associated with the new vector, and heating the cooking appliance according to a pre-programmed cooking mode associated with the corresponding food type, and if no closest one of the plurality of clusters to the new vector is within the predetermined threshold, registering the new vector in a new cluster in the feature space associated with a new food type and heating the cooking appliance according to a user setting in a manual cooking mode.

According to yet another aspect, a multi-dimensional feature space useable by a neural network in classifying a data set includes a plurality of clusters of embedded vectors representing initial data and arranged within the multi-dimensional feature space according to similarity of a predetermined number of features perceived by neural network in the initial data during training of the neural network, and at least one new vector arranged within the multi-dimensional feature space according to the predetermined number of features after training of the neural network and without retraining the neural network.

The at least one new vector may be included in an untrained cluster of new vectors according to similarity of the predetermined number of features.

The embedded vectors may be positioned in the multi-dimensional feature space by the neural network from inputs consisting of images, such that the clusters correspond with classifications related to a general category of subject matter for the images.

The subject matter for the images can be food, and the classifications can be types of food.

The inputs can further consist of non-image food product characteristics.

The multi-dimensional feature space may include a number of dimensions that is equal to the predetermined number of features.

The multi-dimensional feature space may consist of 128 dimensions corresponding to vectors representing 128 features.

The predetermined number of features may include a plurality of subsets of features respectively related to perceived edges, textures, and colors from the image.

According to yet another aspect, a cooking appliance, preferably an oven includes a food-receiving area, preferably an interior cavity, an image sensor outputting image data of at least a portion of the interior cavity, and a controller receiving data including at least the image data. The controller generates a new vector of the data and embeds the new vector in a feature space comprising a plurality of embedded vectors pre-arranged in a plurality of clusters within the space according to similarity of a predetermined number of features represented in the embedded vectors. Each of the plurality of clusters corresponds with a known food type. The controller then determines a closest one of the plurality of clusters to the new vector, within a predetermined threshold, and assigns the corresponding food type to the image data associated with the new vector. If no closest probable one of the plurality of clusters to the new vector is within the predetermined threshold, the controller registers the new vector in a new cluster in the feature space associated with a new food type.

The oven can further include a heating element within the interior cavity, and the controller can further operate the heating element according to a specified program based on the corresponding food type or the new food type.

The specified program based on the new food type can be a manual mode, wherein the controller operates the heating element to achieve a user-selected temperature within the oven cavity for a user-selected duration.

The controller can store the user-selected temperature and the user-selected duration as a new specified program associated with the new food type in memory.

The specified program based on the corresponding food type can be a pre-programmed mode, wherein the controller operates the heating element to achieve a pre-programmed temperature for a predetermined duration associated with the corresponding food type and retrieved from memory.

The controller may generate the new vector of the data and may determine the closest one of the plurality of clusters to the new vector within the predetermined threshold using a convolutional neural network operably associated with the controller.

The new vector can be registered as the new cluster in the feature space by the convolutional neural network operably associated with the controller.

The convolutional network may operate without using a Softmax probability.

The plurality of embedded vectors can be pre-arranged in the plurality of clusters within the feature space according to a training process applied to the convolutional neural network.

The training process can include assessment of the predetermined number of features with respect to the embedded vectors.

The convolutional neural network may determine the closest one of the plurality of clusters to the new vector, within the predetermined threshold, using a Mahalanobis distance from the plurality of clusters.

The Mahalanobis distance from the plurality of clusters to the new vector can be based on a Gaussian Mixture distribution of each of the plurality of clusters.

The controller may further receive a new set of data and may generate a second new vector of the new set of data in the feature space comprising the plurality of clusters and the new clusters within the space. The controller may then determine a new closest one of the plurality of clusters and the new cluster to the second new vector within the predetermined threshold and may assign the corresponding food type to the image data associated with the second new vector.

If no closest probable one of the plurality of clusters to the second new vector is within the predetermined threshold, the controller may register the new vector in a second new cluster in the feature space associated with a second new food type.

The oven can further include a human-machine interface mounted on an exterior surface of the oven, and the controller may cause to be displayed on the human-machine interface one of the corresponding food types in response to determining the closest probable one of the plurality of clusters to the new vector within the predetermined threshold or an indication that the new food type has been detected.

The oven can further include at least one of a gas sensor or a humidity sensor and the data can further include non-image food characteristic data received from the at least one of the gas sensor or the humidity sensor.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. A method for operating a cooking appliance, comprising:
receiving data at least from an image sensor operably associated with a food-receiving area of the cooking appliance, the data comprising an image of a food product;
determining whether the data indicates that the food product corresponds with one of a plurality of known food product types stored in a memory accessible by a controller of the cooking appliance based on an analysis of the data using an identification model accessible by the controller; and
in response to the data indicating that the food product does not correspond with any one of the plurality of known food product types, designating the data as corresponding with a new food product type and causing the new food product type to be added to the plurality of known food product types stored in the memory accessible by the controller of the cooking appliance without retraining the identification model.

2. The method of claim 1, wherein the identification model is embodied in a convolutional neural network that:
includes a plurality of vectors embedded within a multi-dimensional feature space, each of the vectors representing previously-analyzed data comprising prior images of prior food products, the plurality of vectors being located in the multi-dimensional feature space such that ones of the plurality of vectors determined to have relatively higher similarities across a predetermined number of features perceived by the convolutional neural network are grouped in proximity with one another and are separated from other ones of the vectors having a lower similarity across the predetermined number of features; and
identifies ones of the plurality of vectors grouped in proximity with one another as pluralities of clusters of the ones of the vectors and registers the known food product types as respective ones of the plurality of clusters.

3. The method of claim 2, wherein at least some of the embedded vectors are arranged within the multi-dimensional feature space in the clusters according to the similarity of the predetermined number of features during training of the convolutional neural network, the clusters corresponding with different ones of the plurality of know food product types and being separated from each other in the multi-dimensional feature space.

4. The method of claim 2-or claim 3, wherein the analysis of the data includes using the convolutional neural network to generate a new vector from the data and to embed the new vector in the multi-dimensional feature space according to the predetermined number of features.

5. The method of claim 4, wherein, in response to the data not corresponding with any one of the plurality of known food product types, the data is designated as the new food product type and caused to be added to the plurality of known food product types by registering the new vector in a new cluster associated with the new food product type.

6. The method of claim 4, wherein whether the data corresponds with one of the plurality of known food product types accessible by the cooking appliance is determined by the convolutional neural network determining a closest one of the plurality of clusters of the embedded vectors to the new vector within a predetermined probability using a Mahalanobis distance from the plurality of clusters.

7. The method of claim 6, wherein the Mahalanobis distance from the plurality of clusters to the new vector is based on a Gaussian Mixture distribution of each of the plurality of clusters.

8. The method of claim 3, wherein the multi-dimensional feature space is an n-dimensional hypersphere that includes a number of dimensions that is equal to the predetermined number of features.

9. The method of claim 1, further including, in further response to the data not corresponding with any one of the plurality of known food product types, prompting for a user-input of a cooking parameter according to a manual cooking mode.

10. The method of claim 1, wherein the plurality of known food product types comprises a plurality of original food product types and at least one added food type, the added food type having previously been added to the plurality of known food product types accessible to the cooking appliance without retraining the identification model and the plurality of original food product types being developed during training of the identification model.

11. The method of claim 10, further including, in response to the data corresponding with one of the plurality of known food product types that is an added food type, prompting for a user-input of a category name for the added food type.

12-15. (canceled)

16. A cooking appliance, comprising:
a food-receiving area;
a camera including an image sensor outputting an image data of at least a portion of the food receiving area;
a memory having stored therein a plurality of known food product types; and
a controller configured for access to the memory:
receiving a data at least including the image data, the data comprising an image of a food product;
determining whether the data indicates that the food product corresponds with one of the plurality of known food product types stored in the memory based on an analysis of the data using an identification model accessible by the controller; and
in response to the data indicating that the food product does not correspond with any one of the plurality of known food product types, designating the data as corresponding with a new food product type and causing the new food product type to be added to the plurality of known food product types stored in the memory without retraining the identification model.

17. The cooking appliance of claim 16, wherein:
the cooking appliance comprises an oven further including a heating element and an interior cavity defining the food-receiving; and
the controller further operates the heating element according to a specified program in response to the image of the food product corresponding with one of the known food types or the new food type, respectively.

18. The cooking appliance of claim 16, wherein the plurality of known food product types and the identification model are stored in the memory.

19. The cooking appliance of claim 16, wherein the controller accesses at least one of the plurality of known food product types and the identification model over the Internet.

20. The cooking appliance of claim 16, wherein the identification model is embodied in a convolutional neural network that:
includes a plurality of vectors embedded within a multi-dimensional feature space, each of the vectors representing previously-analyzed data comprising prior images of prior food products, the plurality of vectors being located in the multi-dimensional feature space such that ones of the plurality of vectors determined to have relatively higher similarities across a predetermined number of features perceived by the convolutional neural network are grouped in proximity with one another and are separated from other ones of the vectors having a lower similarity across the predetermined number of features; and
identifies ones of the plurality of vectors grouped in proximity with one another as pluralities of clusters of the ones of the vectors and registers the known food product types as respective ones of the plurality of clusters.

21. The cooking appliance of claim 20, wherein at least some of the embedded vectors are arranged within the multi-dimensional feature space in the clusters according to the similarity of the predetermined number of features during training of the convolutional neural network, the clusters corresponding with different ones of the plurality of know food product types and being separated from each other in the multi-dimensional feature space.

22. The cooking appliance of claim 20, wherein:
the analysis of the data includes using the convolutional neural network to generate a new vector from the data and to embed the new vector in the multi-dimensional feature space according to the predetermined number of features; and
in response to the data not corresponding with any one of the plurality of known food product types, the data is designated as the new food product type and caused to be added to the plurality of known food product types by registering the new vector in a new cluster associated with the new food product type.

23. The cooking appliance of claim 22, wherein whether the data corresponds with one of the plurality of known food product types accessible by the cooking appliance is determined by the convolutional neural network determining a closest one of the plurality of clusters of the embedded vectors to the new vector within a predetermined probability using a Mahalanobis distance from the plurality of clusters.

24. A cooking appliance, comprising:
a food-receiving area;
an image sensor outputting image data of at least a portion of the interior cavity; and
a controller:
receiving the image data;
generating a new vector of the image data and embedding the new vector in a feature space comprising a plurality of embedded vectors pre-arranged in a plurality of clusters within the space according to similarity of a predetermined number of features, each of the plurality of clusters corresponding with a known food type;
determining a closest one of the plurality of clusters to the new vector, within a predetermined threshold, and assigning the corresponding food type to the image data associated with the new vector; and
if no closest probable one of the plurality of clusters to the new vector is within the predetermined threshold, registering the new vector in a new cluster in the feature space associated with a new food type.
